(19) United States
(12) Patent Application Publication
(10) Pub. No.: US 2022/0134148 A1
(43) Pub. Date: May 5, 2022

(54) Support System Using Electro-Viscous Fluid

(71) Applicant: Bradley Zang, Jacksonville, FL (US)

(72) Inventor: Bradley Zang, Jacksonville, FL (US)

(21) Appl. No.: 17/090,504

(22) Filed: Nov. 5, 2020

(51) Int. Cl. A62B 35/00; A41D 13/05

(52) U.S. Cl. CPC A62B 35/0006; A62B 35/0025; A41D 13/05

(57) ABSTRACT

A belt will be worn by the individual. Attached to this belt will be a plurality of rolled up legs and gas canisters. Electro-viscous fluid is contained in the harness that will activate the gas canisters; the advantage of using electro-viscous fluid is that it will cause a rapid inflation of the legs with minimal power. On the front of the belt will be an activation device that will send a small electrical charge to engage the gas-powered canisters to quickly inflate the plurality of legs and prevent the person from falling.

### BACKGROUND OF THE INVENTION

### A. Field of the Invention

This is a device that we use for people who are a fall risk. It will consist of a harness which is worn by an individual in the event the person begins to fall or is in danger of falling. It will rapidly deploy a series of support legs that will prevent the person from falling. While the specific number of legs is not mentioned, it will be enough to support an adult and it is likely to be three or four.

Electroviscous fluids are used after a small jolt of power ignites and deploys the leg.

### B. Prior Art

There are many other prior art references to devices that prevent individuals from falling and also discuss the use of electroviscous fluids. A representative example of that discusses electroviscous fluids can be found at Goossens, U.S. Pat. No. 4,668,417. This discusses in general the purpose of electroviscous fluids which is very useful when transmitting powerful forces by means of electronic output such as that used in valves and shock absorbers.

Another representative example in the prior art can be found at Inoue, U.S. Pat. No. 5,607,617. This discusses that electroviscous fluids are stable at both ambient temperatures and elevated temperatures and can be activated using alternating or direct current.

In the current application, it is anticipated that this will be activated using direct current only through a less likely battery system.

For this device they discuss rapid inflation devices including, among others, Gonzaga, U.S. Pat. No. 7,188,518. This is a rapid-in-place device having a supply of pressurized fluid where the holder assembly activates and deactivates the pressurized fluid feeding on the operator's control, the sensors the sensors and the nozzle holder assembly.

The object is to rapidly deploy a device or inflate a device. This does not use electroviscous fluid specifically when used with prior pressurized fluid

Another example in the prior art includes Thomas, U.S. Pat. No. 7,862,082 which is an airbag inflation vessel. When the device is rapidly inflated, it should do it in a totally uniform fashion and a baffle such as discussed in Thomas has been noted in the prior art.

In this case, this application uses a series of gas conduits. There is also a series of smaller gas conduits as well as gas pockets.

Another rapid inflation device can be found at Lin, U.S. Publication 2009/0188570. The instructions in this particular device is substantially different from the current application. Other examples include Sabliere, U.S. Publication 2010/0198249 and Henry, U.S. Publication 2017/0304660.

### BRIEF SUMMARY OF THE INVENTION

This device will consist of a harness which is worn by the individual. The harness may or may not have suspenders but, as drawn, suspenders are anticipated for additional support.

A belt which is connected to the suspenders will also be used. The belt on the belt structure will have a plurality of rolled-up legs which can be deployed. A plurality of gas canisters which are approximate to the rolled-up legs are also provided.

In operation, a battery or a small DC power source will activate the electroviscous fluids, in turn, will cause the rolled-up legs to inflate rapidly by activating the gas canisters.

The device should deploy sufficiently rapidly to prevent a fall of an individual and at least stop the individual from falling completely to the ground.

Within each of the legs will be a series of gas conduits. One will be a central gas conduit already aligned which will be branch off into a plurality of small gas conduits that will have two gas pockets at the end in the center of the structure to provide support.

A sensor will also be provided to show that the device will cease inflating once the sensor strikes the ground.

### BRIEF DESCRIPTION OF THE DRAWINGS

FIG. 1 is an isometric view of the device.

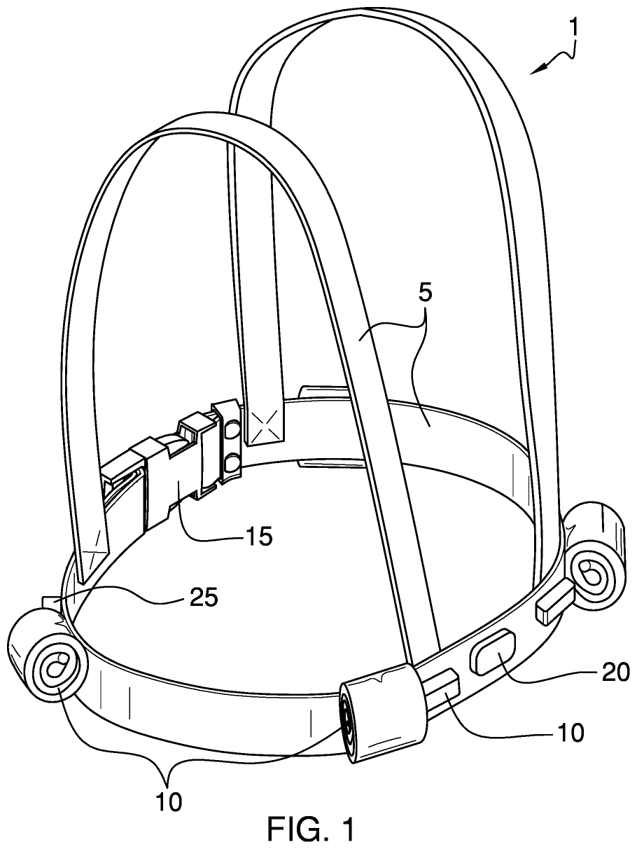

FIG. 2 is a front view of the device.

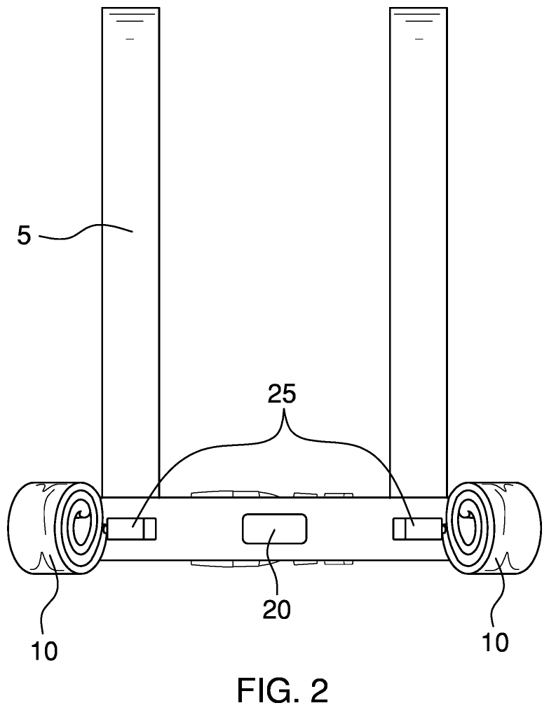

FIG. 3 is a back view of the device.

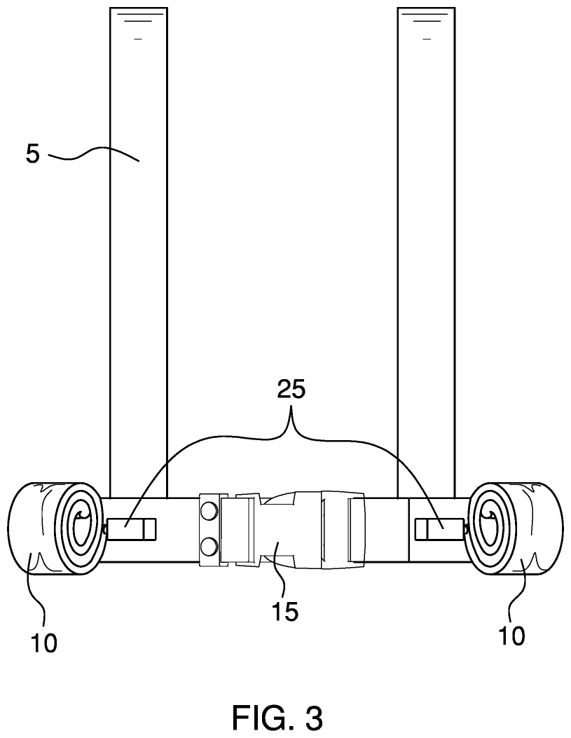

FIG. 4 is an in-use front view.

FIG. 5 is an in-use back view.

FIG. 6 is a detailed view of the rolled-up leg.

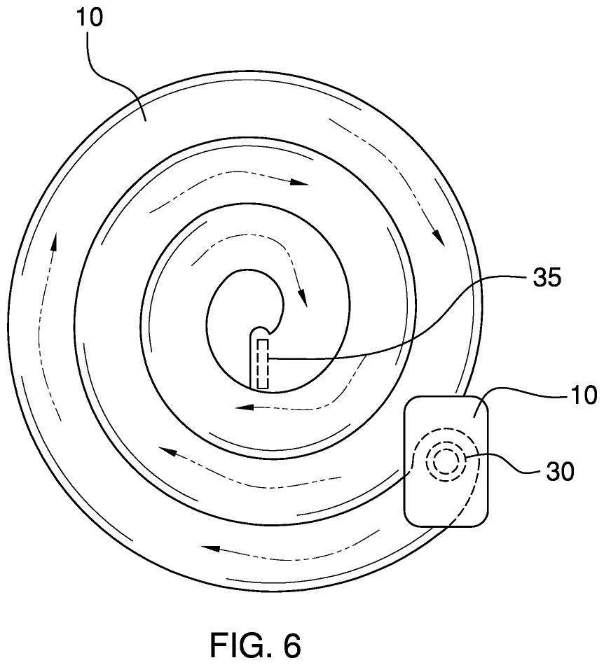

FIG. 7 is a cross-sectional view according to Line 7-7 of FIG. 4.

### NUMBERING DESCRIPTION

1—Device
4—Suspenders
5—Harness
10—Rolled up leg
12—Deployed leg
15—Belt
20—Power Source
25—Gas Canister
30—Valve
35—Sensor
40—Gas Conduit
45—Small Gas Conduit Passages
50—Gas Pocket

### DETAILED DESCRIPTION OF THE EMBODIMENTS

This safety device 1 will consist of a belt 15 with a buckle as well as suspenders 4 that form a part of the harness 5.

Along the exterior of the belt mechanism will be a plurality of rolled-up legs 10 which are attached to the belt. A buckle 15 is placed on the belt to remove the device when needed.

Adjacent and proximate to each of the rolled-up legs 10 will be a plurality of gas canisters 25. Each of the gas canisters 25 will activate a valve 30 that will allow the gas from the gas canister 10 to rapidly inflate the plurality of rolled up legs 10 that are positioned on the belt 15.

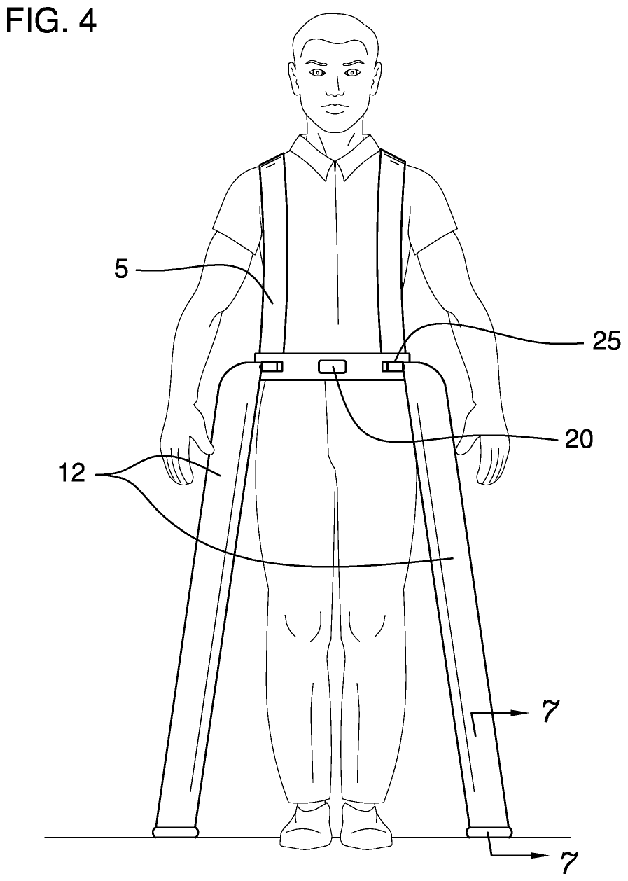

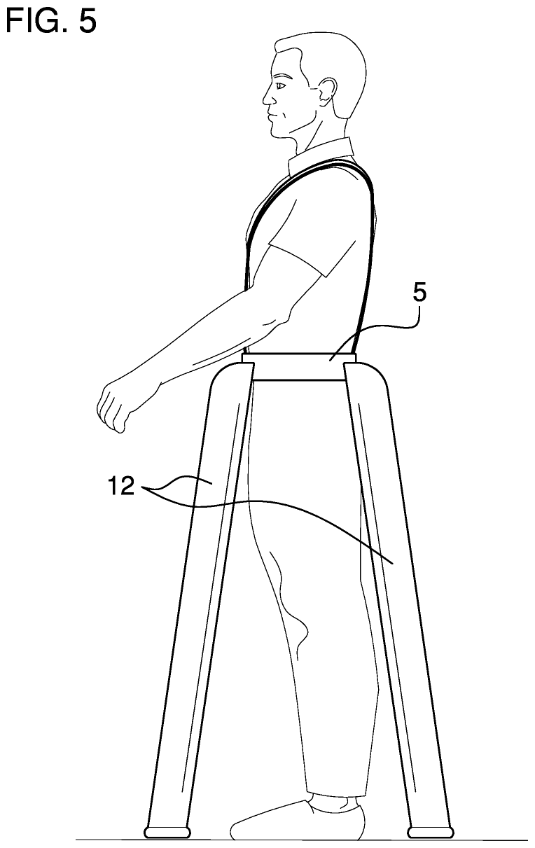

When the device is deployed, a plurality of deployed legs 12 will prevent the person from falling such as depicted in FIG. 4. A sensor 35 on the bottom of each of the legs will detect when the leg is fully deployed and the sensor 35 will provide support for the leg when the leg is fully deployed such as depicted in FIGS. 4 and 5.

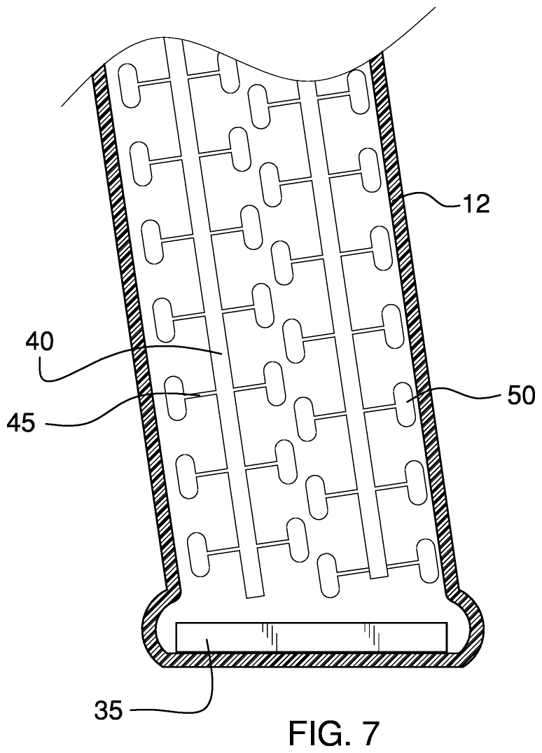

A cross-sectional view of the legs such as depicted in FIG. 7 show a gas conduit 40 that will allow the gas to flow through the conduit and travel through a plurality of small gas conduit passages 45 that lead to a plurality of gas pockets 50 which are located near the outside of the surface of the deployed leg 12.

A small DC power source 20 such as a battery will be used to activate electro-viscous fluids which in turn causes a gas canister 10 to engage. Once the gas canister 10 engages, a valve 30 which is contained and connected to the gas canister will open, forcing gas fluid to flow rapidly through the rolled-up legs 10 as it inflates the leg. A sensor 35 will be contained in each of the rolled-up legs. Once the sensor strikes the ground such as depicted in FIG. 7, the deployed leg should be able to support the weight of a person.

The electro-viscous fluids will be contained within the belt and will cause the gas canisters 25 to deploy. There are multiple types of electro-viscous fluids that are available and no one type is being claimed. All electro-viscous fluids share a common property to cause a chain reaction quickly with very little power input. Regardless of the type of electro-viscous fluid that is being used, the electro-viscous fluid should not be harmful to humans.

While the embodiments of the invention have been disclosed, certain modifications may be made by those skilled in the art to modify the invention without departing from the spirit of the invention.

The inventor claims:

1. A safety device using electroviscous fluids which is comprised of:
a. a harness;
wherein the harness is of a predetermined shape;
b. a buckle;
said the buckle is integral to the harness;
c. a plurality of legs;
wherein the plurality of legs are attached to the harness;
said legs are rolled up when the device has not been activated;
d. a plurality of gas canisters;
wherein a plurality of gas canisters are placed adjacent to the rolled-up legs on the harness;
e. a plurality of valves;
wherein the plurality of valves allow the flow of gas to inflate the leg;
f. a plurality of gas conduit;
wherein the plurality of gas conduit is a predetermined shape;
wherein the plurality of gas conduit extends the length of the leg;
g. a plurality of small gas conduit passages;
wherein the plurality of small gas conduit passages extend outward from the gas conduit;
h. a plurality of gas pockets;
wherein the plurality of gas pockets are attached to the small gas conduits;
i. a power source;
wherein a power source is provided;
j. electro-viscous fluid;
wherein electro-viscous fluids create the reaction to deploy the gas canister and inflate the legs.
